(19) United States
(12) Patent Application Publication
(10) Pub. No.: US 2009/0315737 A1
(43) Pub. Date: Dec. 24, 2009

(54) COMBINATION RENTAL VEHICLE AND PARKING SPACE MANAGEMENT SYSTEM

(75) Inventor: Michel Alain Gilmour, Satu (MY)

Correspondence Address: HOLLAND & HART, LLP, P.O BOX 8749, DENVER, CO, 80201, US

(73) Assignee: Mayalys Limited, Central Hong Kong (CN)

(21) Appl. No.: 12/119,320

(22) Filed: May 12, 2008

(30) Foreign Application Priority Data
May 12, 2007 (FR) 07/03425

(51) Int. Cl. B60Q 1/48

(52) U.S. Cl. 340/932.2

(57) ABSTRACT

The object of the present invention is a rental vehicle fleet management system (V) that includes a server (S) connected (10) to a rental terminal (Bi), which manages a set of parking spaces (Pij), distinguished by the fact that the user carries a communicator (30) that contains an active UHF RFID transmitter (34), which communicates (DU) with the emitting terminals (Bi), and a UHF RFID transmitter that is concealed in the frame of the bicycle, which communicates (DV) with the rental terminals (Bi) or the parking space locking/unlocking systems (Pij).

### FIELD OF INVENTION

The present invention relates to the management of rental vehicles. In particular, the present invention relates to a rental vehicle management system that is enabled by ultra high frequency radio frequency identification (UHF RFID) technology.

### BACKGROUND OF THE INVENTION

A variety of bicycle rental management systems already exist. For example, French Patent No. 2 883 090 describes a system in which bicycles are rented at an interactive terminal located near a bicycle rental station. Under this particular patent, the user has to dismount from the bicycle and type on the keypad of a terminal to make a reservation, return a bicycle, or make a payment. This can be quite inconvenient.

There is also French Patent No. 2 863 752, which describes a bicycle rental system with a locking system built into the bicycle and a control terminal that is activated by mobile phone. This system has the disadvantage of relying on mobile phone operators, and forcing users to own a mobile phone. The mobile phone solution is also expensive.

Further, there is French Patent No. 2 878 349, which describes a bicycle rental system that uses an interactive positioning and reservation device that is equipped with a display screen and mounted on the bicycle. This system draws a significant amount of battery power, is expensive to buy and install, and puts the owner at risk of incurring replacement costs in the event of vandalism.

Further yet, French Patent No. 2 873 475 describes a bicycle rental system based on an interactive terminal that communicates wirelessly with the systems that are installed on the bicycles, and more specifically, with an integrated locking system. This approach also requires significant battery power and is prone to deleterious interference effects common to wireless networks.

Therefore, it is desirable to provide a rental vehicle management system (RVMS) that does not require the driver of a rental vehicle to leave the vehicle in order to conduct transactions regarding the rental of the vehicle. It is also desirable to provide a RVMS that can operate without the users being required to conduct rental transactions through cellular phones. Further, it is desirable to provide a RVMS that is inexpensive, safe from vandals and does not require, or requires very little, battery power.

### SUMMARY OF INVENTION

The present invention is a rental management system that seamlessly combines a fleet of vehicles and a network of pick-up/drop-off stations. The invention is specifically designed for urban clienteles interested in renting bicycles from a number of different locations.

The invention is also suited to other purposes, such as the management of car fleets or parking spots. Potential beneficiaries of the invention include parking lot managers, communities, and companies that would like to provide their customers or employees with vehicles and/or parking spots, which the invention is capable of managing in a highly sophisticated manner. The invention meets the needs of large-scale operators that are interested in responding to the demand from a mobile clientele for an integrated, high-quality vehicle rental and pick-up/drop-off service.

One of the main aspects of the present invention is that of a “remote control” solution, whereby the user can manage the reservation and release of the vehicles or parking spots from a distance, without having to dismount or to walk from the parking space to a reservation terminal.

Another main aspect of the present invention is that of the elimination of the need for mobile phone operators, thanks to a proprietary distance communication system based on wireless UHF RFID technology. The present invention proposes: (1) a simple and ergonomic human-machine interface, (2) an identification system, and (3) a system that is capable of managing multiple users, with none of the kinds of interference that can occur with Wi-Fi or other communication systems.

Yet another of the main aspect of the present invention is that of a simple, accurate system that does not require the installation of potentially expensive and vandalism-prone equipment, and that monitors the bicycle fleet using a UHF RFID device that is concealed in the frame of each bicycle.

Another aspect of the present invention is that of a bicycle rental management system that is simple, economical, and easy to adapt to a fleet of vehicles or bicycles moving between parking stations. It achieves this goal by placing the locking system at the pick-up/drop-off station, rather than on the bicycle itself.

Another aspect of the present invention is that of a bicycle rental management system that operates remotely, and minimizes the distance that users have to walk, thanks to its novel interface.

Another aspect of the present invention is that of a bicycle rental management system with a practical, reliable, and efficient user interface that gives the user a quick, intuitive view of the available options.

Another aspect of the present invention is that of a bicycle rental management system that places the antitheft system at the pick-up/drop-off station, rather than on the bicycle itself.

Another aspect of the present invention is that of a stand-alone station management system.

Another main aspect of the present invention is the combination of a monitoring device carried by the user and a monitoring device secured to, or concealed in, the bicycle.

One aspect of the present invention is that each station is equipped with a discrete interactive terminal, which interacts with both the user's monitoring device and the bicycle's monitoring device.

One aspect of the present invention is that a server manages all of the interactive station terminals.

One aspect of the present invention is that it uses UHF RFID communications technology.

One aspect of the present invention is that the user interface at the pick-up/drop-off station is ergonomic, and operates using LEDs.

One aspect of the present invention is its secure communications network, which includes automatic backup systems with integrated gateways that allow the operator to switch between several different types of networks.

One aspect of the present invention is that is includes a payment system integrated into the user's communicator, which operates using active UHF RFID technology and an EPC (Electronic Product Code) or other system that can also be equipped with encryption.

One aspect of the present invention is that the technology that is embedded in the bicycles is either passive UHF RFID or active standby-mode RFID. Passive RFID does not require a battery, because is uses the energy from the radio waves that it receives for its emission, with a range of only a few metres. Active RFID must be battery-powered, and has a range of several hundred metres. Standby mode refers to an active technology that is in receiving mode, and that does not emit any signals in order to save battery power.

### BRIEF DESCRIPTION OF THE DRAWINGS

Embodiments of the present invention will now be described, by way of example only, with reference to the attached Figures wherein:

FIG. 1 shows an exemplary schematic diagram of a set of parking spaces contemplated by the invention;

FIG. 2 shows an exemplary schematic diagram of the architecture of the invention;

FIG. 3 shows an exemplary UHF RFID communicator contemplated by the invention;

FIG. 4 shows an exemplary network with its system of gateways contemplated by the invention; and

FIGS. 5a and 5b show various exemplary transmission ranges contemplated by the invention.

### DETAILED DESCRIPTION

Even though the examples presented below pertain to the management of a fleet of bicycles, it will be understood by the skilled worker that the invention is equally applicable to other types of vehicles, such as, for example, automobiles.

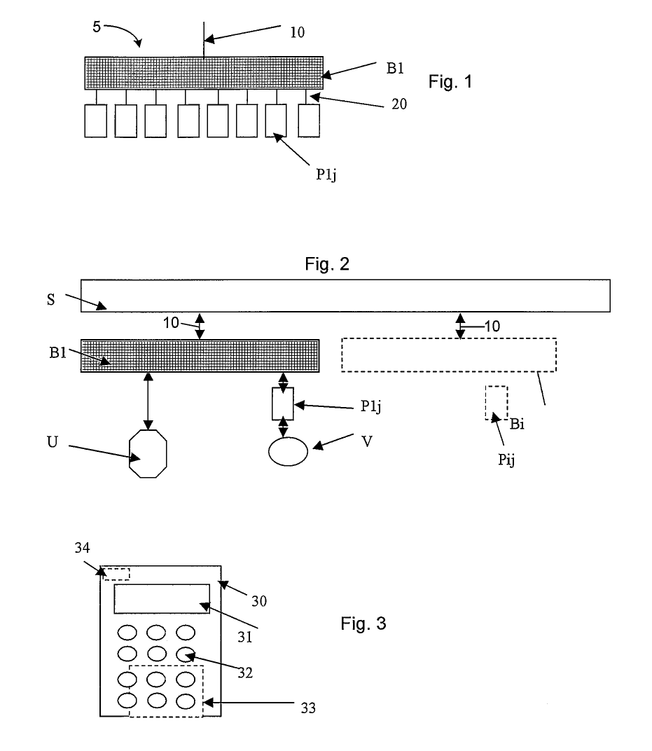

FIG. 1 shows a schematic diagram of a vehicle pick-up/drop-off station 5 managed by the rental management system contemplated by the invention. The station 5 includes a rental terminal B1 in communication (20) with a plurality of parking spots P1j. As is described below, the rental terminal is in communication (10) with a server.

FIG. 2 shows a schematic diagram of the architecture of a rental fleet based on a server (S) hosting a set of data related to the rental fleet. The data can include, for example, data relating to the rental vehicles themselves and their location, and data related to the users registered or liable to use the rental vehicle. The server (S) is linked (10), through any suitable means, to a rental terminal (Bi) located at each of the pick-up/drop-off stations. Each pick-up/drop-off station has a set of parking spaces (Pij). The labelling of the parking spaces (Pij) is such that for rental terminal B1, the “j^{th}” parking space is labelled P1j. The rental terminals (Bi) can be connected (20) to any suitable bicycle locking/unlocking system (not shown) provided at the parking spaces (Pij) associated with the terminal (Bi). The rental terminals (Bi) can communicate with a bicycle fleet and/or with a communicator (30 shown at FIG. 3, the communicator (3) being in possession of a user (U) of a bicycle, and being operable through an active UHF RFID link. Such a link can operate at frequencies ranging, for example, between 433 and 915 MHz. The bicycle fleet includes of a series of bicycles (V).

The bicycle fleet can be accessed by users (U) who also have access to the parking spaces (Pij). The invention can be based on a UHF RFID chip that can be concealed in the frame of each bicycle (V). The UHF RFID chip can be an active standby RFID chip. The UHF RFID chip can also be of the passive type. The bicycle UHF RFID chip is chosen such that it is capable of communicating with both the rental terminal (Bi) and the parking space locking devices (Pij). The invention equips each user (U) with a discrete identification terminal (communicator 30) that also contains a UHF RFID ID chip, which can be of the active type. As shown in FIG. 3, the active UHF RFID chip (34) is housed in the communicator (30) that includes a display screen (31), a keypad (32), a payment card interface (33), and a battery. Using the communicator (30), the user can remotely interact with the rental terminal (Bi) in order to effect payment for the rental of the bicycle. That is, a “wallet” can be integrated into the communicator and recharged using a dedicated card or a prepaid card, or by any other suitable means. In the case of a dedicated or prepaid card, the communicator (30) retrieves the card's key and relays it to the rental terminal (Bi).

By default, the communicator (30) is a standby system, which means that it does not ordinarily emit signals in order to conserve battery power. The communicator (30) switches to emit mode when it receives a UHF frequency transmission from the rental terminal (Bi), or when instructed to do so by the user. One advantage of this approach is efficient management of the communicator's battery power. Unlike GSM mobile phones, which remain in emit mode constantly in order to communicate, and therefore, draws heavily on the battery, the communicator (30) of the present invention does not. In a specific application, the communicator (30) could be integrated into a mobile phone, although the current designs and the variety of mobile phones would make it difficult to integrate an active chip with a sufficiently large transmission range (e.g., 100 metres). The only integrated RFID chips that currently exist are short-range chips, like the ones that are used in integrated payment systems such as swipe cards. However, in the future, integrated RFID chips with larger transmission ranges could be used.

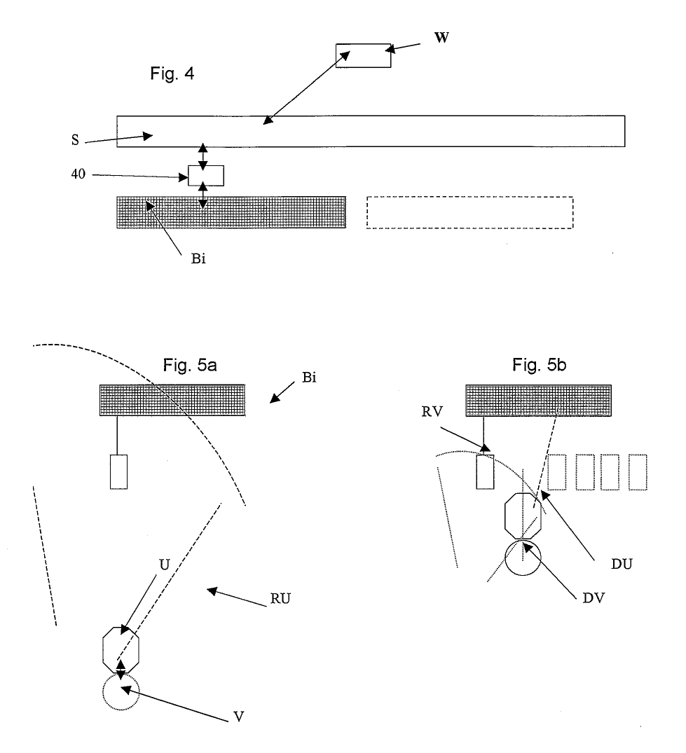

FIG. 4 shows a network with its system of protocol switching and transforming gateways (40) that ensure compatibility with different types of communication networks. The gateways can be of any suitable type and be located between the rental terminal (Bi) and the server (S).

FIGS. 5a and 5b show exemplary various transmission ranges contemplated by the invention. In FIG. 5a, a user (U) on a bicycle (V) approaches a rental terminal (Bi) from a distance of, for example, a few dozen metres. At that distance, the user (U) on his bicycle (V), carrying a communicator (30) equipped with an active UHF RFID chip, communicates (DU) (automatically or upon the user manipulating the communicator (30) to do so) with the rental terminal (Bi) that is within range of the communicator (RU), while the bicycle UHF RFID is invisible to the rental terminal (Bi) and to the parking spaces (Pij) that lie beyond its related transmission range. The rental terminal (Bi), upon receiving the transmission from the communicator (30), reserves a parking space for the arriving bicycle (V) and communicates to the communicator (30) the identification of the parking space in question, which can be displayed on the display (31) of the communicator (30). Of course, in the case of a pre-arranged reservation, the transmission received at the rental terminal (Bi) from the communicator (30) can serve to confirm the reservation. Further, a visual indicator at the parking space in question can be activated to draw the attention of the user (U). Such visual indicators can include lights of any kind, including light emitting diodes (LEDs). Of course, light sources of different colours, in concert with pre-determined blinking patterns can be used to convey different messages. For example, a green light with a bicycle present in the associated parking space could mean that the bicycle is available and, a red light with bicycle in the parking space could mean that the bicycle is reserved.

Upon the user (U) approaching the parking space within, for example, a few dozen centimetres, the bicycles standby or passive mode UHF RFID chip located in, or secured to, the bicycle connects with the transmitter of the specific parking space (Pij) that has been reserved in advance and prepared by the arrival of the active communicator (30), as shown in FIG. 5a. The standby or passive mode UHF RFID chip of the bicycle can then start communicating (DV) with the rental terminal (Bi). A bicycle locking system can be located at the parking space (Pij) and be in communication with the transmitter of the parking space in question and with the rental terminal (Bi). Upon the bicycle having been locked at the parking space (Pij), the rental transaction can be completed in any suitable manner, including any manner including an electronic wallet present in the communicator (30). In cases where the rental vehicle in question is a car, a lock box for the car keys, or any other suitable locking device or system, could be used instead of a bicycle locking system.

This particularly ingenious combination of two transmission systems—the active active communication system associated with the user equipped with the communicator (30) and the passive communication system associated with the bicycle UHF RFID—not only allows for highly efficient management of the locking/unlocking systems of the specific parking spaces (Pij), but also allows remote electronic payment. In a specific version, the range (RV) of the bicycle's standby or passive mode RFID chip can be adjustable, depending on the particular applications, by either the fleet manager or by the user of the bicycle/vehicle that is equipped with the passive or standby mode chip.

It is evident that combinations of a great number of variants could be contemplated within the framework of the invention as defined hereinafter. For example, it is possible to integrate into each parking space locking/unlocking system (Pij), a transmission system that communicates directly with the bicycle (V) or with the user (U).

Therefore, the subject of the invention is a management system for rental vehicle fleets (V) and rental terminals (Bi) distinguished by the fact that the user carries a communicator (30) that is equipped with an active UHF RFID transmitter (34), which communicates (DU) with the rental terminals (Bi), while a UHF RFID transmitter that is secured to, or concealed in, the frame of the bicycle communicates (DV) with the rental terminals (Bi) or the parking space (Pij) locking/unlocking systems.

Therefore, the subject of the invention is a management system for rental vehicle fleets (V) and rental terminals (Bi) distinguished by the fact that the transmitter that is integrated into the bicycle is a passive UHF RFID or active standby mode UHF RFID transmitter.

Therefore, the subject of the invention is a management system for rental vehicle fleets (V) and rental terminals (Bi) distinguished by the fact that the transmitter that communicates with the rental terminal (Bi) causes LEDs to flash on the locking/unlocking system (Pij) of a vehicle's dedicated parking space (V).

Therefore, the subject of the invention is a management system for rental vehicle fleets (V) and rental terminals (Bi) distinguished by the fact that the rental terminals (Bi) are in communication (20) with the locking/unlocking system of each of the parking spaces (Pij) associated with the terminal (Bi).

Therefore, the subject of the invention is a management system for rental vehicle fleets (V) and rental terminals (Bi) distinguished by the fact that the active UHF RFID chip (34) is housed in a communicator (30) that includes a display screen (31), a keypad (32), a payment card interface (33), and a battery.

Therefore, the subject of the invention is a management system for rental vehicle fleets (V) and rental terminals (Bi) distinguished by the fact that the communicator (30) is integrated into a mobile phone.

Therefore, the subject of the invention is a management system for rental vehicle fleets (V) and rental terminals (Bi) featuring a network of communication protocol switching or transforming gateways (40).

Therefore, the subject of the invention is a management system for rental vehicle fleets (V) and rental terminals (Bi) distinguished by the fact that a transmission system in each parking space locking/unlocking system (Pij) communicates directly with the bicycle (V) or with the user (U) (via a communicator).

In the above description, for purposes of explanation, numerous details have been set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A rental bicycle fleet (V) management system including a server (S) connected (10) to rental terminals (Bi), each of which manages a set of parking spaces (Pij), distinguished by the fact that the user carries a communicator (30) equipped with an active ultra high frequency (UHF) radio frequency identification (RFID) transmission system (34), which in turn communicates (DU) with the rental terminals (Bi), and a UHF RFID transmitter concealed in the frame of the bicycle, which communicates (DV) with the rental terminals (Bi) or the parking space locking/unlocking systems (Pij).

2. The system as claimed in claim 1, distinguished by the fact that the transmitter that is integrated into the bicycle is a passive UHF RFID or active standby mode RFID transmitter.

3. The system as claimed in claim 1, distinguished by the fact that the transmitter that communicates with the rental terminal (Bi) causes LEDs to flash on the locking/unlocking system (Pij) of the bicycle's dedicated parking space (V)

4. The system as claimed in claim 1, distinguished by the fact that the terminals (Bi) are wired (20) to the parking space locking/unlocking systems (Pij) that are connected to the rental terminal (Bi)

5. The system as claimed in claim 1, distinguished by the fact that the active UHF RFID chip (34) is housed in a communicator (30) that consists of a screen (31), a keypad (32), a payment card interface (33), and a battery.

6. Rental vehicle fleet (V) and rental terminal (Bi) management system under claim 5, distinguished by the fact that the communicator (30) is integrated into a mobile phone.

7. The system as claimed in claim 1, distinguished by the fact that it includes a network of communication protocol switching or transforming gateways (40).

8. The system as claimed in claim 1, distinguished by the fact that a transmission system in each parking space locking/unlocking system (Pij) communicates directly with the bicycle (V) or with the user (U).

9. A management system for a fleet of vehicles, the system comprising:
a server;
a terminal in communication with the server, the terminal for managing a set of parking spaces, at least one of the parking spaces having a locking system for locking a vehicle;
a communication device (CD) to be carried by a user of the vehicle, the CD having a CD-operating range and an ultra high frequency radio frequency identification (UHF RFID) transmitter for transmitting a first signal to the terminal upon being within the CD-operating range; and
a UHF RFID vehicle transmitter chip (VTC) secured to the vehicle, the VTC having a VTC-operating range, the VTC for transmitting a second signal to at least one of the terminal and the locking system upon the at least one of the terminal and the locking system being within the VTC-operating range.
